(19) United States
(12) Patent Application Publication
(10) Pub. No.: US 2018/0338517 A1
(43) Pub. Date: Nov. 29, 2018

(54) FISH GELATIN PREPARATION

(71) Applicants: Nathan Spira, Brooklyn, NY (US); Yehuda L Fasten, Brooklyn, NY (US); Chaim Tauber, Brooklyn, NY (US)

(72) Inventors: Nathan Spira, Brooklyn, NY (US); Yehuda L Fasten, Brooklyn, NY (US); Chaim Tauber, Brooklyn, NY (US)

(21) Appl. No.: 15/603,866

(22) Filed: May 24, 2017

(51) Int. Cl. A23L 17/00

(52) U.S. Cl. CPC A23L 17/70; A23V 2002/00

(57) ABSTRACT

A method of preparation and use of fish gelatin for foods, and in particular a powdered fish gelatin that can be easily reconstituted and used for traditional dishes such as jelled fish sauce. The fish sauce jelly in a powder form is produced from fish scales which, when put into a cooking fish pot, will become a jelly after it is refrigerated, to replace traditional fresh fish skin that was used as a jelling agent. The fish gelatin it is made out of scales from fish such as tilapia that has undergone a deodorizing and dehydrating procedure, and is crushed into a powder.

### FIELD OF THE INVENTION

The present invention relates to a preparation and use of fish gelatin for foods, in particular for fish sauce.

### BACKGROUND OF THE INVENTION

Gefilte fish is a dish made from a poached mixture of ground deboned fish, such as carp, whitefish, or pike, which is typically eaten as an appetizer. It is a dish traditionally served by Ashkenazi Jewish households. Although the dish historically consisted of a minced-fish forcemeat stuffed inside the fish skin, as its name implies, since the 19th century the skin has commonly been omitted and the seasoned fish is formed into patties similar to quenelles or fish balls. Typically, a broth made from the fish skin, bones and head, as well as savories such as carrots, onions, parsley and the like, is simmered and then strained and chilled. The chilled broth gels and is served with the fish patties or balls.

Because of the time consuming nature of making the fish jelly, it is now made by food processors and sold in jars. However, this shortcut is not as appetizing, and as a result many people forego the entire process of fish skin cooking.

### SUMMARY OF THE INVENTION

The present application provides a method of preparation and use of fish gelatin for foods, and in particular a powdered fish gelatin that can be easily reconstituted and used for traditional dishes such as Gefilte fish and/or traditional cooked fish. The fish sauce jelly in a powder form is produced from fish scales which, when put into a cooking fish pot, will become a jelly after it is refrigerated, to replace traditional fresh fish skin that was used as a jelling agent. The fish gelatin it is made out of scales from fish such as tilapia that has undergone a deodorizing and dehydrating procedure, and is then crushed into a powder.

### DETAILED DESCRIPTION OF THE PREFERRED EMBODIMENTS

The present application provides a method of preparation and use of fish gelatin for foods, and in particular a powdered fish gelatin that can be easily reconstituted and used for traditional dishes such as Gefilte fish and/or traditional cooked fish. The fish sauce jelly in a powder form when put into a cooking fish pot, will become a jelly after it is refrigerated, and replaces traditional fresh fish skin that was used as a jelling agent.

In a preferred embodiment, the powdered fish gelatin is made out of scales from one or more fish such as pike, mullet, carp, bronzini, tilapia and buffalo fish. Preferably, the scales derive primarily or exclusively from tilapia. The scales of the fish are acid treated for deodorizing then washed and filtered. The clean scales are then dried and sterilized. After cooling, the scales are dehydrated and then crushed to the desired granularity, such as a powder of 40 mesh particle size. After proper mixing, the powder is then packed into consumer-size jars which are labeled with ingredients and usage information. Preferably, there are no chemicals, preservatives or carrageenan (seaweed product often used for thickening) added. The all natural powdered fish gelatin is relatively inert and stays fresh for a number of years without refrigeration.

To use, the powdered fish gelatin is mixed with hot, preferably boiling, water to form a sauce. One typical formula is adding about 4 teaspoons of the powdered fish gelatin to about 6 cups (48 fluid oz.) of boiling water. The sauce may be combined with other ingredients such as savories like carrots, onions, parsley, and simmered to blend all the flavors. After filtering and a suitable period of chilling, the fish sauce gels and can be served with various foods such as in a Gefilte Fish and/or traditional cooked fish recipe.

While the invention has been described in its preferred embodiments, it is to be understood that the words which have been used are words of description and not of limitation. Therefore, changes may be made within the appended claims without departing from the true scope of the invention.

What is claimed is:

1. A method of making a fish jelly for a food dish, comprising:
procuring a powdered fish gelatin;
reconstituting the powdered fish gelatin by adding an amount to hot water;
chilling the reconstituted fish gelatin to form a jelly; and
serving the jelly with a food dish.

2. The method of claim 1, wherein the powdered fish gelatin is formed of dried fish scales of a fish selected from the group consisting of pike, mullet, carp, bronzini, tilapia and buffalo fish.

3. The method of claim 2, wherein the dried fish scales are deodorized, dehydrated and crushed into a desired particle size.

4. The method of claim 3, wherein the desired particle size is 40 mesh particle size.

5. The method of claim 3, wherein the powdered fish gelatin has no chemicals, preservatives or carrageenan added.

6. The method of claim 1, wherein the powdered fish gelatin is formed of dried fish scales of one or more fish selected from the group consisting of pike, mullet, carp, bronzini, tilapia and buffalo fish.

7. The method of claim 6, wherein at least one of the fish is tilapia and the amount of tilapia is greater than the other type of fish.

8. The method of claim 1, wherein the powdered fish gelatin is formed of dried tilapia scales.

9. The method of claim 1, wherein the step of reconstituting the powdered fish gelatin comprises adding an amount to boiling water.

10. The method of claim 1, wherein the step of reconstituting comprises adding about 4 teaspoons of powdered fish gelatin to about 6 cups of boiling water.

11. The method of claim 1, wherein the food dish is Gefilte Fish.
